(19) United States
(12) Patent Application Publication
(10) Pub. No.: US 2010/0225026 A1
(43) Pub. Date: Sep. 9, 2010

(54) Mould release composition

(75) Inventors: Preben Madsen, Helsingborg (SE); Kai Salo, Espoo (FI)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/310,913

(22) PCT Filed: Sep. 14, 2007
(86) PCT No.: PCT/EP2007/059736

§ 371 Date: Apr. 15, 2010

(30) Foreign Application Priority Data
Sep. 15, 2006 (EP) 06120760.1

(51) Int. Cl. B28B 7/36

(52) U.S. Cl. 264/338

(57) ABSTRACT

The present invention relates to a mould release composition comprising an aqueous emulsion of an oil, wherein the emulsion comprises preferably at least one organic acid, preferably at least one ester surfactant such as monoglycerides of lower alkanoic acids; preferably at least one further ester of polyethylene glycol and oleic acid, and preferably at lest one ether surfactant, said composition further comprising colloidal silica, said mould release composition providing an environmentally friendly, biodegradable, mould release composition and surface improver giving a rapid and lasting strengthening of the surface of the concrete rendering the surface more dense or hardened.

### BACKGROUND OF THE INVENTION

1. Field of the Invention

The present invention relates to a mould release composition comprising a mould release agent in combination with a concrete surface hardener.

When casting moulded concrete bodies, e.g. structural elements such as buildings or bridges or elements therefore or crash barriers or the like measures have to be taken in order to obtain a satisfactory surface of the product and in order to ensure that the product will slip the mould without leaving residues of concrete ruining the surface of the product and disturbing future castings using the same mould.

In order to allow the mould to be released from a moulded concrete body when said concrete body has been fully or partially set, it is necessary to apply a release composition to the mould for providing a physical chemical film before the moulding process, i.e. before the concrete composition is poured into the mould. The action of a mould release composition is partly based on the principle that the curing of the concrete surface is delayed or even prevented so that the concrete body does not adhere to the surface of the mould when the concrete body is removed. The delay in curing or the prevention of curing must only apply to a very thin layer of the concrete body so that the strength of the concrete surface is not affected or is only affected to a minor extent.

Such compositions must fulfil various demands, i.e. they must be able to adhere to a certain amount to the mould, they must impart retarding influence to the surface layer of the concrete, they must have a suitable viscosity index so that they can be sprayed onto the surface of the mould both in winter and in summer temperature conditions, and they should have a minimum hazardous effect on the environment.

Another way of obtaining a release capability is to apply a hydrophobic release composition so that the cured concrete will not adhere to the mould.

Release compositions used hitherto are normally based on mineral oils, and as additives were normally used kerosene in order to act as a viscosity decreasing agent, retarding agents for improving the release properties, and other additives which may be wetting agents, adhesives and corrosion-protective agents. Normally, known release compositions contain 65-99% by weight of mineral oil and kerosene and 1-35% by weight of additives.

2. Description of the Related Art

EP 0 180 630 discloses that the release of a moulded concrete body from the mould can be improved by applying to the mould an effective amount of a concrete release composition comprising mineral oil and/or one or more oily esters of aliphatic carboxylic acids with mono- or dihydric alcohols, with a melting point of at the most 35° C., the total number of carbon atoms in the esters being 8-46, in an amount of 26-100% by weight, calculated on the total composition, optionally in admixture with other additives such as mineral oils, vegetable oils, glycols, glycol ethers, alkanols, emulsifiers and/or water.

It has been proposed to improve the surface of a cast concrete product. It is desired to obtain a homogeneous, dense, strong and tight surface rapidly in order to enable an early de-moulding and in order to delay undesired carbonization of the concrete.

Thus, JP7060736 discloses a mould releasing agent comprising a polymer resin which is soluble in alkali and insoluble in water, which resin will polymerise to form a continuous film layer at the surface of the concrete, said polymerised layer functioning as a mould releasing agent and providing a smooth surface on the cast concrete product. The polymer resin comprises a siliceous fine powder such as fumed silica or blast furnace slag dispersed in an aqueous suspension or solution of the polymer and giving a pozzolanic effect. The obtained dispersion is applied to the inner surface of a form and dried. Thereafter, a concrete product is cast, and a coating is gradually swelled and dissolved. On the surface of the concrete removed from the form, a fast and smooth surface cured layer is formed. This method requires the use of melted pre-polymer and provides a surface of the concrete body comprising the polymer.

In many countries and especially in Scandinavian, local regulations tend to prohibit mould releasing agents (MRA) that contains hydro carbonates based on mineral oil. Mineral oil based MRAs are not degradable under anaerobic conditions and can by leaking or from washing water used for equipment in concrete production, in plant or on site, pollute the ground water.

Another aspect of the subject mould release agents is that very often too much such agent is used. This causes poor surfaces visually and gives weak and dusty surfaces.

Thus, there is a need of an environmentally friendly, biodegradable mould release composition avoiding dust problems. Furthermore there is a need of a surface improver or surface hardener for use in the production of concrete products without changing the surface properties by inclusion of other components such as polymers.

### SUMMARY OF THE INVENTION

The present invention relates to a mould release composition for moulds for casting of products of concrete, said composition comprising an aqueous emulsion of an oil, wherein the emulsion, preferably the oil phase, comprises preferably at least one ester surfactant, preferably at least one organic acid, preferably at least one further ester of polyethylene glycol and oleic acid, and preferably at least one ether surfactant, said composition further comprising colloidal silica.

In a second aspect the invention relates to a method for producing a mould release composition for moulds for casting of products comprising hydraulic binding agents, preferably concrete, said method comprising the steps of

a) preparing an oil-in-water emulsion by adding the one or more organic acids, such as fatty acids, the one or more ester surfactants and the one or more ether surfactants to water, homogenizing the emulsion to give oil droplets having a size below 5 μm,

b) preparing an aqueous suspension of colloidal silica, and

c) adding the suspension of colloidal silica of step b) to the emulsion prepared in step a).

In a third aspect the invention relates to a use of the composition of the invention as a mould release composition or as a surface hardener for improving the release of a moulded body, preferably a moulded concrete body, from the mould, by applying an effective amount of the mould release composition of the invention to the surfaces of the mould that are to be in contact with the moulded body.

In a forth aspect the invention relates to a method for casting a product comprising hydraulic binding agents, preferably a concrete product, said method comprising the steps

a) providing a mould of a shape corresponding to the desired product,

b) applying an effective amount of a mould release composition of the invention to the surfaces of the mould that is to be in contact with the composition comprising hydraulic binding agents,

c) pouring the composition comprising hydraulic binding agents into the mould,

d) allowing the composition comprising hydraulic binding agents to harden at least partially, and

e) de-moulding the product, preferably the concrete product.

### DETAILED DESCRIPTION OF THE PRESENT INVENTION

In its broadest aspect the invention relates to a mould release composition for moulds for casting of products comprising hydraulic binding agents such as cement or slags, preferably products of concrete or mortar, said composition comprising an aqueous emulsion of an oil in combination with a concrete surface hardener. The concrete surface hardener is preferably colloidal silica.

Thus, the overall idea of the invention is to produce mould release compositions, preferably based on ester oils, said mould release compositions comprising colloidal silica as a surface hardener, and wherein water is used as the viscosity modifying solvent.

The term “colloidal silica” is understood here and hereinafter to mean silica sol which is a stable disperse system in which the dispersion medium is a liquid, preferably water, and the disperse or discontinuous phase is silicon dioxide in the colloidal state. The amount of finely dispersed silica in the colloidal state is preferably from 5 to 50% by weight based on the total weight of the dispersion, preferably between 10 and 30% by weight. The finely dispersed silica particles preferably have a diameter between 1 and 100 nm, more preferably between 3 and 50 nm, most preferably between 6 and 40 nm.

The present invention relates to a mould release composition comprising an aqueous emulsion of an oil, preferably an oil-in-water emulsion, and colloidal silica. The oil phase comprises one or more oil component, preferably white petroleum jelly, paraffin oil, or white oil.

In a preferred embodiment, the emulsion, preferably the oil phase, comprises at least one ester. Esters useful for the composition of the invention are e.g. organic esters of a fatty acid having from about 14 to about 36 carbon atoms, preferably palmitic acid, margaric acid, stearic acid, oleic acid, nonadecanoic acid or icosanoic acid, with a lower alkanol having up to 6 carbon atoms, preferably isobutyl oleate or n-butyl oleate. Preferred esters which can be used for the mould release composition of the invention are ester surfactants, preferably monoglyceride of lower alkanoic acids having up to 6 carbon atoms such as formic acid, acetic acid, propionic acid or butyric acid. Preferably, the oil phase further comprises at least one further ester of polyalkylene glycol, preferably polyethylene glycol such as PEG 600, PEG 400 or PEG 200, and oleic acid, preferably a polyethylene glycol mono-oleate or a polyethylene glycol sorbitan mono-oleate. In a very preferred embodiment, the composition of the invention comprises at least one ester surfactant and at least one further ester of polyalkylene glycol and oleic acid. Even more preferably, the mould release composition of the invention comprises at least one ester surfactant, at least one further ester of polyalkylene glycol and oleic acid, and at least one further organic ester of fatty acid having from about 14 to about 36 carbon atoms.

In another preferred embodiment, the oil phase comprises at least one organic acid, preferably at least one fatty acid having from about 14 to about 36 carbon atoms, preferably palmitic acid, margaric acid, stearic acid, oleic acid, nonadecanoic acid or icosanoic acid.

In yet a further embodiment, the oil phase comprises at least one ether surfactant, preferably an alkyl substituted phenol polyglycol ether or an ethylene oxide/propylene oxide block copolymer.

The emulsion of the mould release composition of the invention can comprise further components including without limitation one or more alkylene glycols such as ethylene glycol or propylene glycol, a base such as an amine, preferably ammonia, sodium or calcium hydroxide, further esters, and/or further emulsifiers or stabilizers or ingredients known to the skilled person in the art.

Preferably, the mould release composition of the invention comprises an aqueous emulsion of an oil comprising at least one organic acid, at least one ester surfactant, at least one further ester of polyethylene glycol and oleic acid, and/or, at least one ether surfactant, said composition further comprising colloidal silica.

Most preferably, the mould release composition of the invention comprises an aqueous emulsion of an oil comprising at least one organic acid, at least one ester surfactant, at least one further ester of polyethylene glycol and oleic acid, and at least one ether surfactant, said composition further comprising colloidal silica.

More particular, the invention relates to a mould release composition, said composition comprising an aqueous emulsion of an oil such as an organic ester of oleic acid with a lower alkanol having up to 6 carbon atoms such as isobutyl or n-butyl oleate, wherein the oil phase comprises one or more organic acids, such as fatty acids having from about 14 to about 36 carbon atoms, e.g. palmitic acid, margaric acid, stearic acid, nonadecanoic acid or icosanoic acid; one or more ester surfactants such as monoglycerides of lower alkanoic acids having up to 6 carbon atoms such as formic acid, acetic acid, propionic acid or butyric acid; one or more further esters of polyethylene glycol such as PEG 600, PEG 400 or PEG 200 and oleic acid or polyethylene glycol sorbitan monooleate and one or more ether surfactants such as an alkyl substituted phenol polyglycol ether or a ethylene oxide/propylene oxide block copolymer, said composition further comprising colloidal silica.

The present invention provides an environmentally friendly, biodegradable, mould release composition and surface improver fulfilling requirements for biodegradability according to OECD 301D. Furthermore, it has been found that when using such biodegradable mould release compositions in the form of an oil-in-water emulsion it is possible to incorporate colloidal silica in a simple manner in the form of an aqueous suspension of the silica enabling the use of water as a viscosity controlling agent and providing an accelerated surface hardening and a strengthening effect. At the same time, dust problems are avoided.

In accordance with the invention the emulsification of the ester oil in water is assisted by addition of emulsifiers. In order to secure stability it is preferred to homogenize release agent in a manner known per se. After homogenisation the oil droplets suitably have a having a size below 5 μm and, preferably below 1 μm.

Silica is normally used as concrete stabilizer and it has not been proposed to test the surface hardening effect of colloidal silica in a mould release composition. Until now it has been considered impossible to combine colloidal silica with a mould release agent due to the conventional use of different phases (organic/inorganic) when handling the release compositions and silica. It has now been found that by making an oil-in-water emulsion of the release agent before adding the colloidal silica and adding the colloidal silica as a suspension in water it is possible to combine colloidal silica into a stable mould release composition.

When utilising the present invention a mould for casting bodies of a composition comprising a hydraulic binding agent, such as concrete mortar, is coated with the mould release composition according to the invention and then the colloidal silica is available when the concrete or mortar is cast. Then, the colloidal silica will react with calcium hydroxide available in abundant supply in the surface layer of the concrete. The colloidal silica particles are very reactive and provide a rapid establishment of a strong and relatively impervious surface layer. This reaction is taking place within the first 8 to 24 hours and provides cement-like strengthening bindings. The rate of reaction depends of the particle size of the colloidal silica and the effect depends on the amount of silica transferred to the surface of the concrete from the mould release composition, i.e. the amount of silica present in the mould release composition controlled by the mixing ratio of oil-in-water emulsion and the colloidal silica suspension of silica particles in water.

It is suitable that a composition according to the invention comprises from 1 to 25% by weight of colloidal silica, more preferred from 2 to 15% by weight of colloidal silica, calculated on the total weight of the composition.

A composition according to the invention suitably comprises an aqueous emulsion of a dihydric alkanol, ammonia, a saturated fatty acid, a mono unsaturated fatty acid ester, a semi solid mixture of hydrocarbons, paraffin oil, and an acetic acid monoglyceride ester in water.

A concrete surface hardener may be selected from colloidal silica in the form of discrete particles having a size below 100 nm.

For the purpose of the present invention it is possible to obtain mould release compositions having a viscosity of from 6 to 40 mPa*s, such as from 5 to 30 mPa*s, e.g. from 7 to 25 mPa*s and in particular from 15 to 20 mPa*s by varying the particle size of the colloidal silica and the ratio of the oil-in-water emulsion of the oil phase and the suspension or dispersion comprising colloidal silica.

Typical and preferred mould release compositions according to the invention comprise from 50 to 65% by weight of water such as soft water, ion exchanged water, demineralised water or distilled water, from 5 to 10% by weight of one or more alkylene glycols such as propylene glycol or ethylene glycol, a base such as an amine, preferably ammonia, or sodium or calcium hydroxide in an amount of from 0.01 to 0.03% by weight, one or more organic acids, such as fatty acids having from about 14 to about 36 carbon atoms e.g. palmitic acid, margaric acid, stearic acid, oleic acid, nonadecanoic acid or icosanoic acid in an amount from 0.2 to 0.7% by weight; one or more oil components such as petroleum jelly or paraffin oil or white oil in an amount from 9 to 13% by weight, one or more ester surfactants such as monoglycerides of lower alkanoic acids having up to 6 carbon atoms such as formic acid, acetic acid, propionic acid or butyric acid in an amount from 0.5 to 2% by weight; one or more further esters of polyethylene glycol such as PEG 600, PEG 400 or PEG 200 and oleic acid, or polyethylene glycol monooleate or polyethylene glycol sorbitan monooleate in an amount from 1.8 to 2.6% by weight and/or one or more ether surfactants such as an alkyl substituted phenol polyglycol ether or an ethylene oxide propylene oxide block copolymer in an amount of from 0.5 to 1.5% by weight, said composition further comprising colloidal silica in an amount of from 2 to 15% by weight of the total composition.

In a second aspect the invention relates to a method for producing a mould release composition of the invention for moulds for casting of products of compositions comprising a hydraulic binding agent, such as e.g. concrete or mortar, said method comprising the steps of

a) preparing an oil-in-water emulsion by adding the one or more organic acids, such as fatty acids, the one or more ester surfactants and/or the one or more ether surfactants to water, homogenizing the emulsion to give oil droplets having a size below 5 μm,

b) preparing an aqueous suspension of colloidal silica, and

c) adding the suspension of colloidal silica to the emulsion prepared in step a).

In accordance with a preferred embodiment, the emulsion is homogenized to give oil droplets having a size below 1 μm.

In the method of the invention an aqueous suspension of colloidal silica is added to an oil-in-water emulsion. This means that silica is added in the form of discrete single particles. These particles are very small, preferably with a diameter between 1 and 100 nm, and preferably have a very large surface area up to 1,200 m²/g, preferably between 80 and 1,000 m²/g, more preferably between 200 and 750 m²/g, and are extremely reactive in or on fresh concrete. The use of silica in the concrete industry per se is known and the silica reacts with the reaction products from the reaction of cement and water (pozzolanic effect) and provides an increase in strength and density being 4 to 6 times greater than that of cement. It is established that silica increases the durability of the concrete significantly as the concrete becomes more impermeable for water and penetration of chloride, CO₂ etc.

Especially the effect against CO₂ is important because the pore-water in hardened concrete has a very high pH about 14. In this environment the reinforcement is passivated meaning that it cannot corrode. If steel reinforcement corrodes, the resulting rust having a larger volume than the steel that has corroded steel and will break the concrete body. Over time CO₂ will penetrate into the concrete and cause a so-called carbonisation thereof. This will have the effect that the pH of the pore-water drops to about 7 and in this environment the steel reinforcement is no longer passivated and may start corroding. The speed with which the carbonisation front reaches the steel reinforcement depends on the density and strength of the surface of the concrete.

Normally silica is used in the form of fumed silica having a chain-like structure of clusters of primary particles. There is no mentioning of directly using colloidal silica which is in the form of individual primary particles having a cast surface and being extremely reactive which was now found to render colloidal silica especially suitable for use as a surface hardener for the purpose of the present invention.

Colloidal silica being suitable for the purpose of the present invention typically has a particle size below 100 nm and a surface area of up to 750 m² per gram or even more. Typical commercially available colloidal silica products have a particle size of e.g. from 4 to 100 nm, from 3 to 50 nm or from 6 to 40 nm.

In a third aspect the invention relates to the use of the composition of the invention as a mould release agent or as a surface hardener. In particular, the composition of the invention is used for improving the release of a moulded concrete body from the mould, said method comprising applying an effective amount of a mould release composition to the surfaces of the mould that are to be in contact with the concrete. Also other compositions comprising a hydraulic binding agent such as cement or slag or the like, such as for example mortar bodies can be formed.

In a forth aspect the invention relates to a method for casting a product of a composition comprising a hydraulic binding agent such as cement or slag, said method comprising the steps

a) providing a mould of a shape corresponding to the desired product,

b) applying an effective amount of a mould release composition of the invention to the surfaces of the mould that is to be in contact with the composition comprising a hydraulic binding agent such as cement or slag,

c) pouring the composition comprising a hydraulic binding agent such as cement or slag into the mould,

d) allowing the compositions comprising a hydraulic binding agent such as cement or slag to harden at least partially, and

e) de-moulding the product.

Preferably, the composition comprising a hydraulic binding agent such as cement or slag is concrete or mortar.

### EXAMPLES

### Preparation of Mould Release Compositions According to the Invention

Mould release compositions were made by producing an oil-in-water emulsion comprising about 58.5% by weight of water, about 7% by weight of alkylene glycols, about 0.02% by weight of a base, about 11.4% by weight of one or more oil components such as petroleum jelly or paraffin oil or white oil, about 0.5% by weight of one or more organic acids; about 22.6% by weight of one or more ester surfactants, about 1% by weight of one or more ether surfactants, the aggregate of the constituents of the emulsion adding up to 100%. The emulsion was combined with an amount of an aqueous dispersion of colloidal silica comprising about 15% by weight of solid silica particles based on the total weight of the dispersion, providing a total amount of colloidal silica in the composition of 5, 10 and 15% by weight based on the total weight of the composition comprising the emulsion and the colloidal silica dispersion.

Casting experiments were carried out using moulds made from wood, cold-rolled steel and stainless steel.

The mould release composition was used for treating moulds for casting concrete by spraying in a manner known per se and then concrete was cast in the moulds. After removal of the product from the mould after 24 hours, the procedure was repeated several times.

It was found that it was possible to remove the products from the mould as early as 8 hours after casting and still to obtain the benefits of the invention.

Blocks of concrete having dimensions of 40×40×4 cm³ were cast in moulds made from wood and moulds made from black iron. Blocks of concrete having dimensions of 30×30×10 cm³ were cast in moulds made from stainless steel. Furthermore, wall units having dimensions of 3×4×0.1 and 3×4×0.15 m³ using conventional industrial technique were produced.

The resulting products had surfaces completely without voids and pin holes, which surfaces were very smooth and free of dust.

Even after several castings using the same mould, the non-stick capability was intact, and no concrete was accumulated in the moulds.

1. A mould release composition comprising an aqueous emulsion of an oil, and colloidal silica.

2. The mould release composition according to claim 1, wherein the aqueous emulsion is an oil-in-water emulsion.

3. The mould release composition according to claim 1, wherein said oil comprises one or more oil component.

4. The mould release composition according to claim 1, wherein said colloidal silica is a dispersion comprising silica particles in the colloidal state with a diameter of 1 to 100 nm.

5. The mould release composition according to claim 1, wherein said emulsion comprises at least one ester.

6. The mould release composition according to claim 5, wherein said at least one ester is at least one monoglyceride of lower alkanoic acids having up to 6 carbon atoms.

7. The mould release composition according to claim 1, wherein said emulsion further comprises at least one organic acid.

8. The mould release composition according to claim 7, wherein said at least one organic acid is fatty acid having from about 14 to about 36 carbon atoms.

9. The mould release composition according to claim 1, wherein said emulsion further comprises at least one ester of polyalkylene glycol and oleic acid.

10. The mould release composition according to claim 1, wherein said emulsion further comprises at least one ether surfactant.

11. The mould release composition according to claim 10, wherein said at least one ether surfactant is an alkyl substituted phenol polyglycol ether or an ethylene oxide/propylene oxide block copolymer.

12. The mould release composition according to claim 1, wherein the aqueous emulsion further comprises from 1 to 25% by weight of colloidal silica based on the total weight of the mould release composition.

13. The mould release composition according to claim 1, wherein the aqueous emulsion further comprises from 2 to 15% by weight of colloidal silica based on the total weight of the composition.

14. The mould release composition according to claim 1, wherein the aqueous emulsion further comprises a dihydric alkanol, ammonia, a saturated fatty acid, a mono unsaturated fatty acid ester, a semi solid mixture of hydrocarbons, paraffin oil, an acetic acid monoglyceride ester, in water, and colloidal silica.

15. A method for producing a mould release composition of claim 1, the method comprising:
a) preparing an oil-in-water emulsion by adding the one or more organic acids, such as fatty acids, one or more ester surfactants and/or one or more ether surfactants to water, homogenizing the emulsion to give oil droplets having a size below 5 μm,
b) preparing an aqueous suspension of colloidal silica, and
c) adding the suspension of colloidal silica prepared in step b) to the emulsion prepared in step a).

16. The method according to claim 15 wherein the emulsion is homogenized to give oil droplets having a size below 1 μm.

17. A method of releasing a moulded concrete body from a mold, the method comprising:
applying the mould release composition according to claim 1 as a mould release agent or surface hardener for improving the release of the moulded concrete body from the mould by applying an effective amount of the mould release composition to the surfaces of the mould that are to be in contact with the concrete.

18. A method for casting a concrete product, the method comprising:
a) providing a mould of a shape corresponding to the desired product,
b) applying an effective amount of a mould release composition according to claim 1 to the surfaces of the mould that are to be in contact with the concrete,
c) pouring concrete into the mould,
d) allowing the concrete to harden at least partially, and
e) de-moulding the concrete product.
